(19) United States
(12) Patent Application Publication
(10) Pub. No.: US 2018/0289214 A1
(43) Pub. Date: Oct. 11, 2018

(54) Fogatta, La Caja Boricua

(71) Applicant: Omar Martinez, Bayamon, PR (US)

(72) Inventor: Omar Martinez, Bayamon, PR (US)

(21) Appl. No.: 15/480,496

(22) Filed: Apr. 6, 2017

(51) Int. Cl. A47J 37/07

(52) U.S. Cl. CPC A47J 37/0704; A47J 37/07; A47J 37/0763

(57) ABSTRACT

Imagine a marriage between a regular cooking oven, and a charcoal BBQ. What would come out of this 2 if we crossed them? An apparatus with the convenience of use of an oven, and the great flavors and aromas of a BBQ. An apparatus that is easy to use, and yet has an unlimited potential of what you can cook on it. It cooks fast, delivering juicy and flavorful cuts of meats, poultry, fish, or anything you want to throw at it, without having the concern that the drippings from your meats will ignite with the charcoal and burn your foods. We did this by repositioning the charcoal to the side, which we called the charcoal side burner (CSB). By doing this, we now have a box that cooks like an oven and gives your meats the flavors and aromas of charcoal.

La Caja Boricua is the first portable charcoal side roaster oven. It is fabricated with plywood, and then laminated on the inside with stainless steel. It has 2 other components which are the charcoal side burner (CSB) and the cooking grills (see drawings). It works just like an oven, but the difference is the location of the charcoal or heating element which is located on the side instead of in the bottom and the position of the grill which is placed vertical instead of horizontally. By rearranging the position of these 2 elements we came with a completely new, efficient, fun, easy and flavorful cooking method. When placing the charcoal to the side, you don't have to worry about the fat drippings that come out of meats, igniting and burning your meat. Instead, and because of the position of the grills, those fats can be collected in a tray and then be used or simply discarded. In addition, meats will be impregnated with the aromas of the charcoal and cooking times are reduced and charcoal consumption is minimum. Simply, light your charcoals in the charcoal basket using any traditional method, season your meats, put them in the grills and inside the box and let them cook, flipping your meats only once during the process by simply turning around the grills.

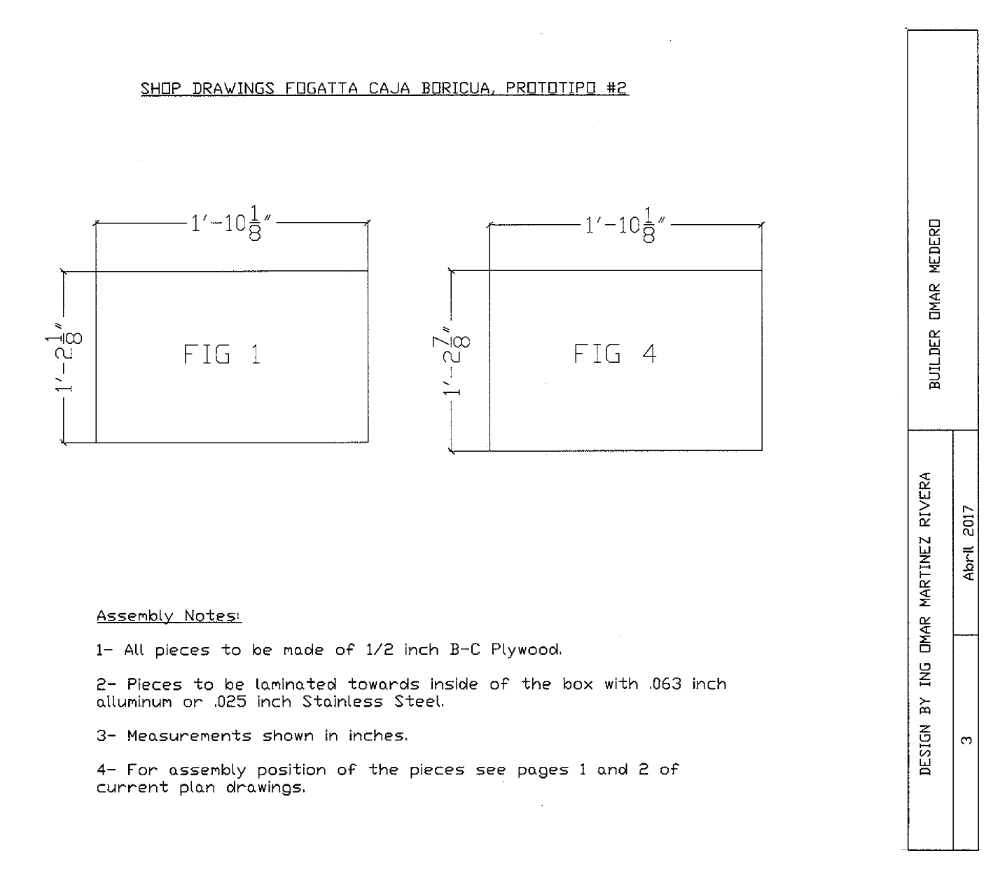

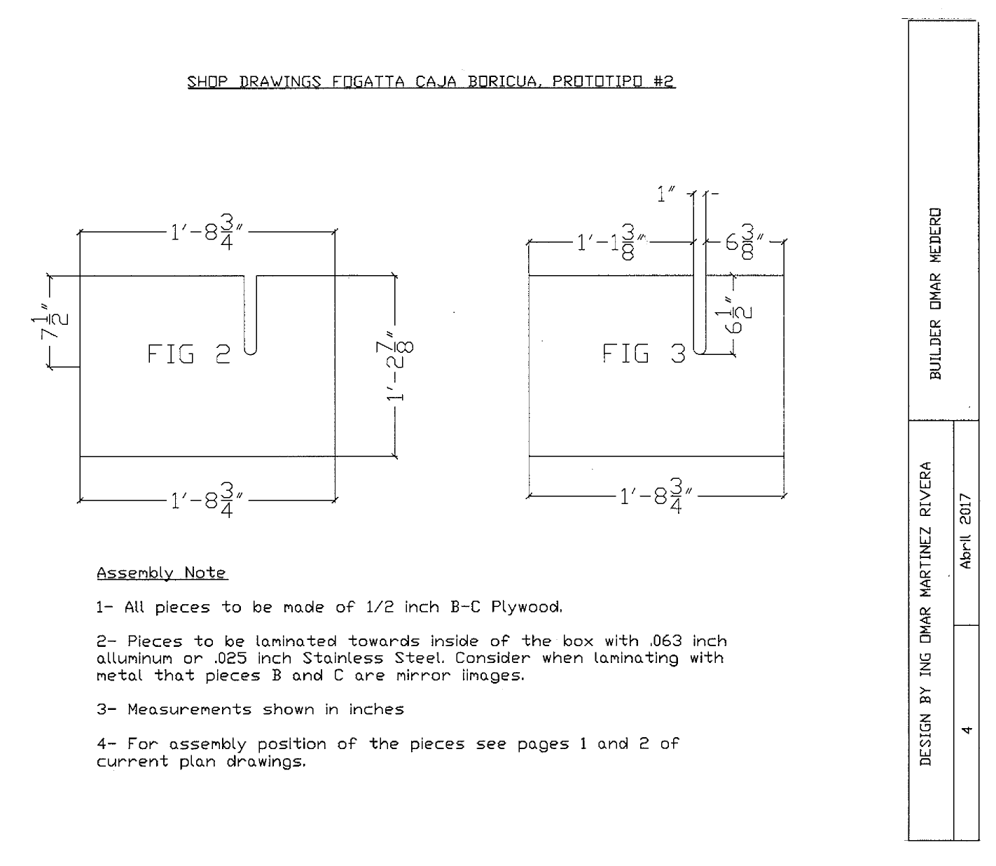

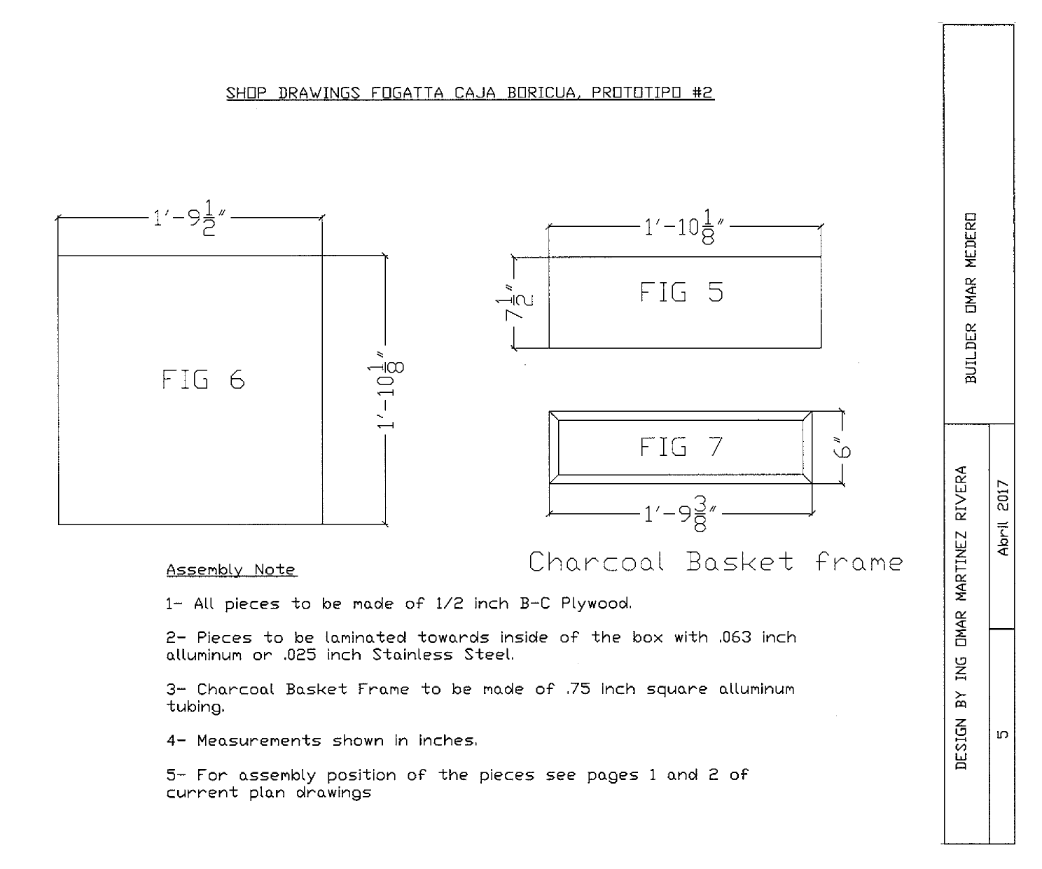

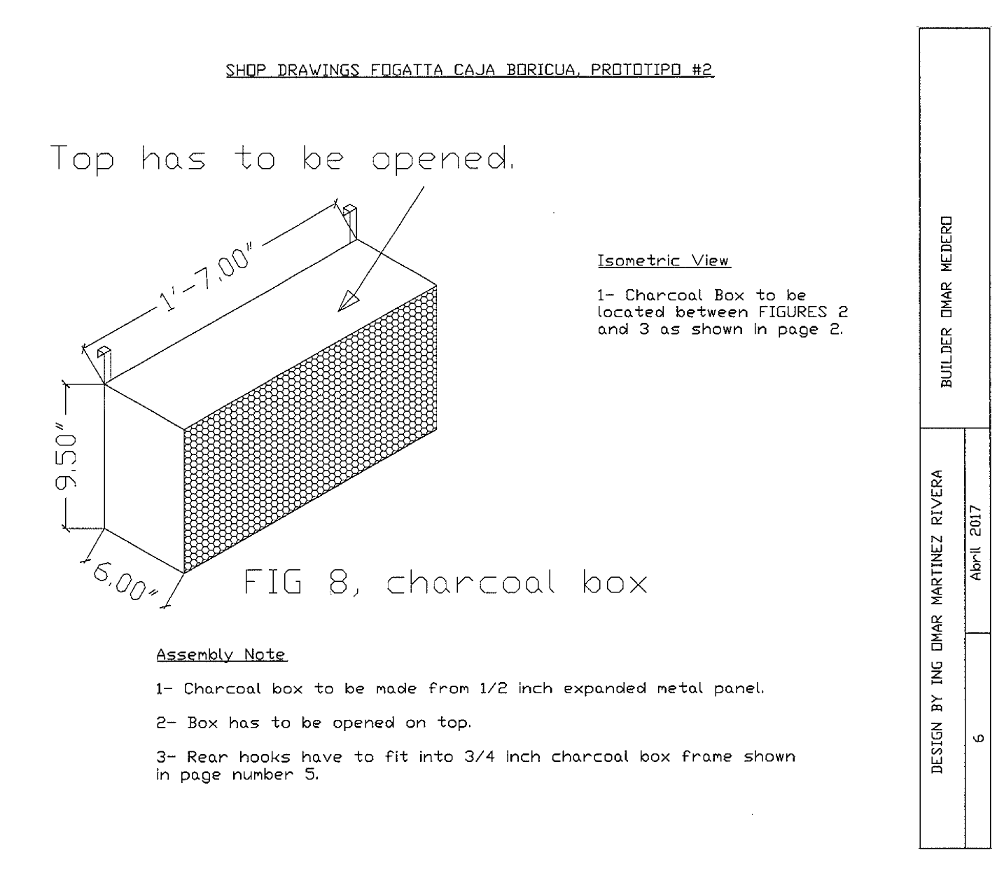

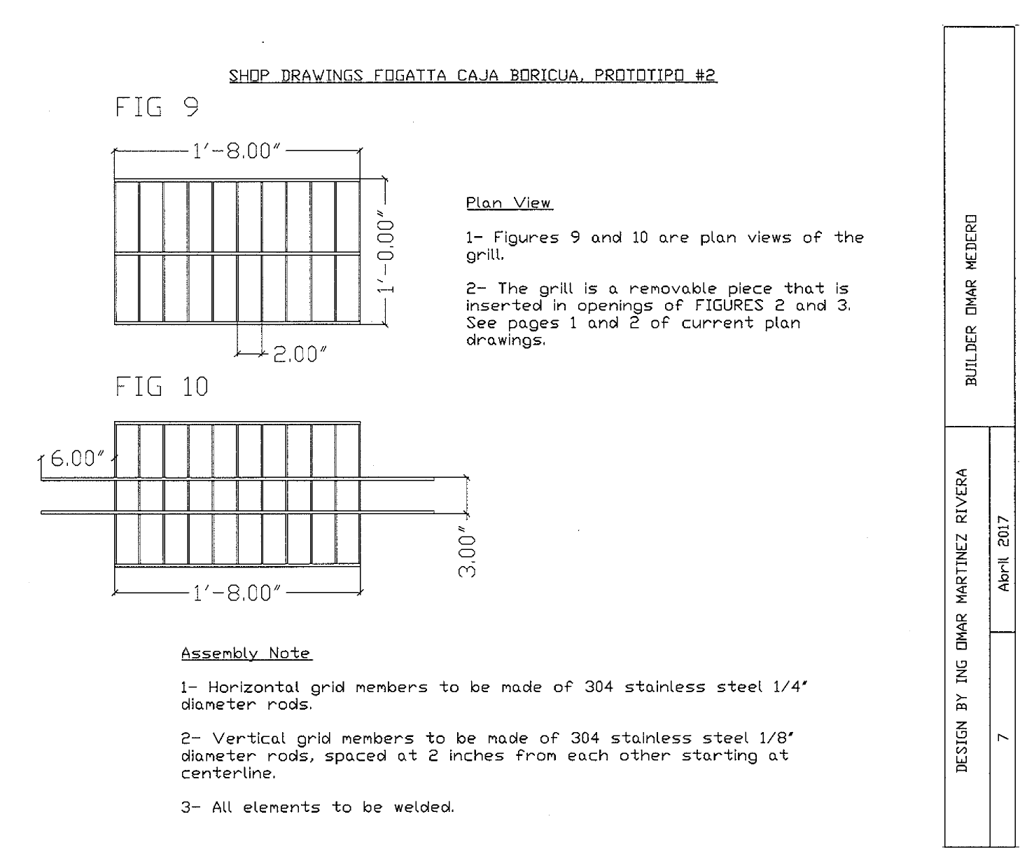

Drawings are included with this specification. In page 1 of the drawings, an assembled ‘Caja Boricua’ is shown, with each of its components labeled, from FIG. 1 thru FIG. 6. In page number 2, an exploded isometric view can be seen, and it illustrates the position of FIGS. 1 thru 5 when assembly is done. Page number 3, shows the dimensions of FIGS. 1 and 4. Page number 4 shows the dimensions of FIGS. 2 and 3. Page number 5 shows the dimensions of FIGS. 5, 6 and 7. Page number 6, shows the dimensions of the charcoal side burner, figure number 8. And finally, page number 7, shows the dimensions of the grills, FIGS. 9 and 10. All of the drawings include assembly notes, along with specifications of materials to be used.

1. The rearrangement of the heating element to the side and the vertical grills resulted in a clean, healthy, fun, innovative and highly efficient cooking method. You can have the charcoal inside of the oven without the risk of burning your meats because of the drippings falling on top of the charcoals. It also looks beautiful, since you can see from the outside the burning charcoals which looks like a chimney. We called this the ‘Charcoal Side Burner’ or CSB.
